(19) United States
(12) Patent Application Publication
(10) Pub. No.: US 2026/0251190 A1
(43) Pub. Date: Aug. 27, 2026

(54) CABLE GRAB CARRIER SLEEVE

(71) Applicant: SAFEWAZE LLC, Concord, NC (US)

(72) Inventors: Owen P. JEWELL, Centreville, MD (US); Cortland G. SCHURIAN, Concord, NC (US)

(73) Assignee: SAFEWAZE LLC, Concord, NC (US)

(21) Appl. No.: 19/544,393

(22) Filed: Feb. 19, 2026

Related U.S. Application Data
(60) Provisional application No. 63/761,670, filed on Feb. 21, 2025.

(51) Int. Cl. F16D 63/00; A62B 35/00

(52) U.S. Cl. CPC F16D 63/008; A62B 35/0081

(57) ABSTRACT

A cable sleeve for use with a safety cable for a fall protection system is presented. The cable sleeve is designed for secure attachment between a safety worker and a vertical lifeline such as those commonly found along a ladder. The cable sleeve includes a bi-directional locking mechanism, designed to lock the cable sleeve in place relative to the safety cable in case of a fall, or when the worker panics during a fall, as well as a dual-action locking cover to prevent the cable sleeve from inadvertently disconnecting from the safety cable. An anti-inversion safety feature and other visual safety indicators are also disclosed.

### FIELD OF THE INVENTION

The present disclosure, in some embodiments, relates to a cable climbing sleeve for use with climbing ladder fall arrest systems designed to protect workers ascending to and descending from elevated heights.

### BACKGROUND

Climbing ladder fall arrest safety systems are designed to prevent individuals from fall-related injuries while ascending or descending fixed ladder systems. Typically, fixed ladder systems are installed in permanent or semi-permanent locations, which require workers to regularly ascend and descend to elevated positions such as those commonly found on communication towers, wind turbines, construction scaffolding, and on utility poles.

In addition to providing peace of mind to workers, OHSA regulations require workers to use a climbing ladder fall arrest system when ascending to and descending from elevated positions under certain circumstances. A properly set-up climbing ladder fall arrest system is configured so that if a worker falls off of a ladder while ascending or descending, their body is stopped prior to contact with the ground or any other objects below.

### BRIEF SUMMARY OF THE INVENTION

Embodiments of the present disclosure present a cable climbing sleeve for use with a climbing ladder fall arrest system. In some embodiments, the cable climbing sleeve is designed to be the secure attachment point between a safety cable and a full body harness.

As a worker ascends or descends a fixed ladder system, the presently disclosed cable climbing sleeve is designed to travel along a pre-installed safety cable with the wearer. Said cable climbing sleeve is designed to move freely along the safety cable, then rapidly lock in place during a fall. Certain embodiments may also incorporate features that satisfy certain safety standard requirements including a multi-directional engagement system, anti-inversion protection, and visual lock status indicators. These and other novel aspects for a cable sleeve will be apparent from the detailed description below. This disclosure including the detailed description should in no way be construed to limit any claimable subject matter regardless of whether the subject matter is presented in claims of the application as it is initially filed or in subsequent claims amended or otherwise presented during prosecution of this disclosure.

### BRIEF DESCRIPTION OF THE DRAWINGS

FIG. 1 illustrates a perspective view of a ladder fitted with presently disclosed cable sleeve as part of a fall protection system, according to one embodiment.

FIG. 2 illustrates a perspective view of an exemplary cable sleeve, according to one embodiment.

FIG. 3 illustrates an exploded view of an exemplary cable sleeve, according to one embodiment.

FIG. 4 illustrates a perspective view of the chassis of an exemplary cable sleeve, with the top cover removed, according to one embodiment.

FIG. 5 illustrates a perspective view of an exemplary cable sleeve with the top cover removed, according to one embodiment.

FIG. 6 illustrates an exploded view of the cam locking mechanism located within the chassis of an exemplary cable sleeve with the top cover removed, according to one embodiment.

FIG. 7 illustrates a side view of an exemplary cable guide, according to one embodiment.

FIG. 8 illustrates an exploded view of an exemplary harness attachment subassembly, according to one embodiment.

FIG. 9A illustrates a side view of an exemplary cable sleeve in the neutral position with the top cover removed according to one embodiment.

FIG. 9B illustrates a side view of an exemplary cable sleeve with the activation arm in the upward position with the top cover removed according to one embodiment.

FIG. 9C illustrates a side view of an exemplary cable sleeve with the activation arm in the downward position with the top cover removed according to one embodiment.

FIG. 9D illustrates a side view of an exemplary cable sleeve with the activation arm in the downward position with the top cover removed according to a first alternative embodiment.

FIG. 9E illustrates a side view of an exemplary cable sleeve with the activation arm in the downward position with the top cover removed according to a second alternative embodiment.

FIG. 10 illustrates an exploded view of the sliding cover, the fixed upper cover, and the dual action locking cover mechanism according to one embodiment.

FIG. 11A illustrates a side view of the cable sleeve with the sliding cover fully extended, according to one embodiment.

FIG. 11B illustrates a side view of the cable sleeve with the sliding cover partially extended, according to one embodiment.

FIG. 11C illustrates a side view of the cable sleeve with the sliding cover fully retracted, according to one embodiment.

### DETAILED DESCRIPTION

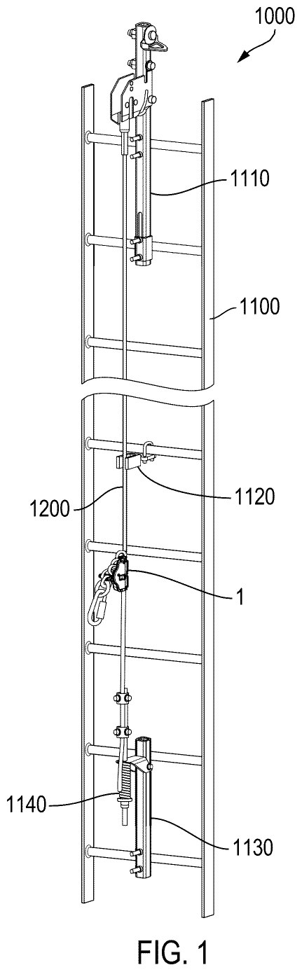

Disclosed herein is a cable sleeve for use in a personal fall protection system 1000. In some embodiments, such as the embodiment shown in FIG. 1, the personal fall protection system 1000 may be designed for use when ascending or descending a semi-permanently affixed ladder 1100. Often the safety system 1000 will include a top bracket 1110, one or more middle brackets 1120, and a bottom bracket 1130 which are designed to hold a safety cable 1200 securely in place relative to the ladder 1100. In certain embodiments, the top bracket 1110 may be affixed to the top of the ladder, and the bottom bracket 1130 may be affixed to the bottom of the ladder 1100. The safety cable 1200, according to some embodiments, may run parallel to the ladder 1100, and may extend from the bottom bracket 1130 to the top bracket 1110, passing through one or more middle brackets 1120 as needed in order to keep the safety cable 1200 in position relative to the ladder 1100. In some embodiments, the bottom bracket 1130 may include a tensioner device 1140 which allows a worker to adjust the tension of the safety cable 1200 prior to ascending the ladder 1100.

Certain safety systems 1000, such as that shown in FIG. 1, may utilize a cable sleeve 1 which acts as the main connection point between the safety cable 1200 and a harness worn by a person. The cable sleeve 1 is one aspect of a personal fall arrest system which allows a worker to safely ascend or descend a ladder 1100 while remaining securely attached to the safety cable 1200. In some embodiments, the cable sleeve 1 may be configured for unrestrained vertical travel along the safety cable 1200, but is designed to lock up (or greatly reduce the descent speed) in the event of a worker falling off of the ladder 1100. By locking the cable sleeve 1 in place relative to the safety cable 1200, or greatly reducing its descent speed down the safety cable 1200, the cable sleeve 1 slows or arrests a worker's fall, thereby preventing or greatly reducing injuries sustained from accidental falls from permanently affixed climbing apparatuses such as ladders 1100.

Disclosed herein is a cable sleeve 1 for use with a safety cable 1200 in a personal fall protection system 1000. More particularly, the cable sleeve 1 described herein includes a multi-directional cable engagement mechanism, which engages the locking mechanism of the cable sleeve 1 both during a fall and during inadvertent contact with the cable sleeve 1 resulting from a panicked grab of the cable sleeve 1. The cable sleeve 1 described herein also may include a dual action locking cover mechanism. Neither the multi-direction cable engagement mechanism nor the dual action locking cover mechanism as described herein are previously known in the art. In addition to the disclosure of these unique safety mechanisms, multiple visual safety engagement indicators are presented. As will be described in more detail, the multi-directional cable engagement mechanism is designed to prevent accidental disengagement of the cable sleeve's 1 locking ability by uncontrolled contact with the cable sleeve 1 by panicked workers in the instance of a fall. Said anti-panic mechanism will lock the cable sleeve 1 relative to the safety cable 1200 regardless of whether a downward or upward force is applied to the cable sleeve 1. Likewise, the dual action locking cover mechanism prevents the cable sleeve 1 from accidental disengagement from the safety cable 1200 during use, and includes multiple visual indicators alerting the operator when the safety mechanism has been disengaged thereby allowing a worker to make visual inspections regarding the status of their attachment to the safety cable 1200 while ascending or descending.

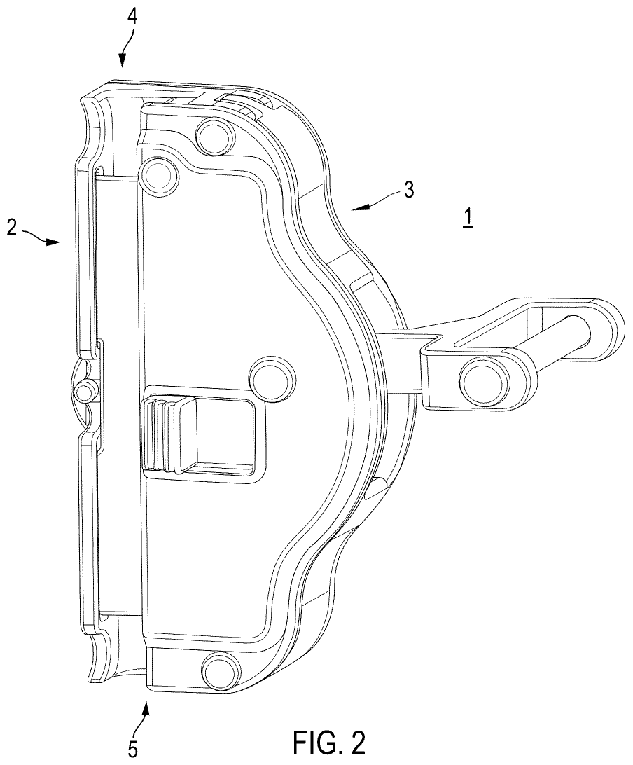

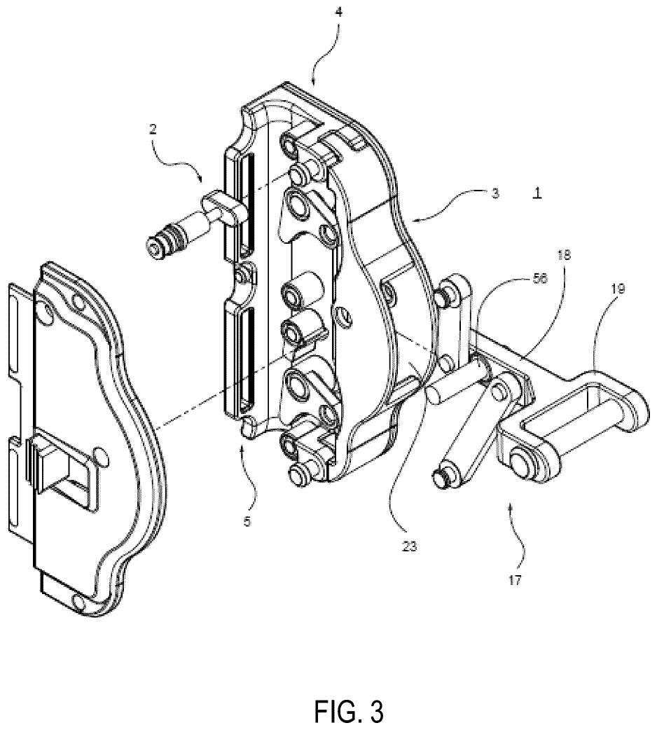

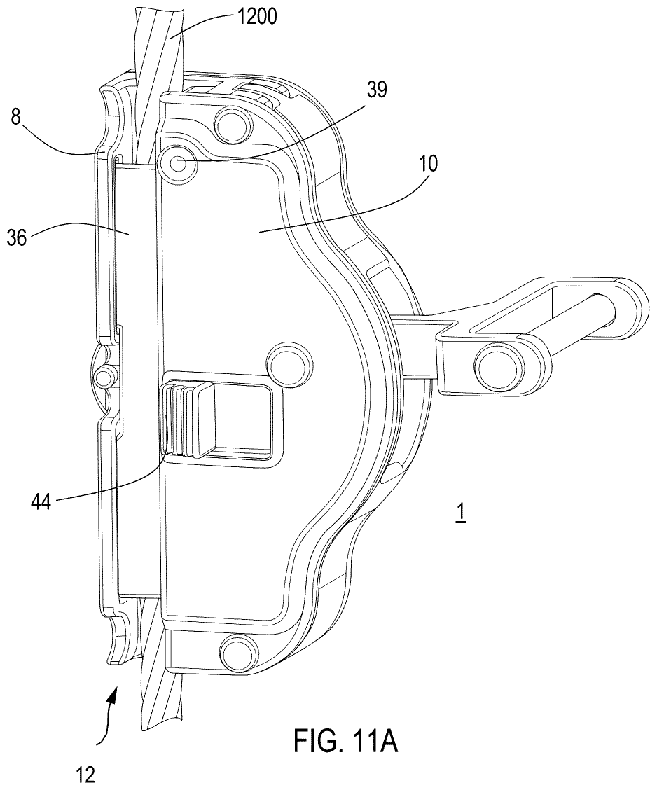

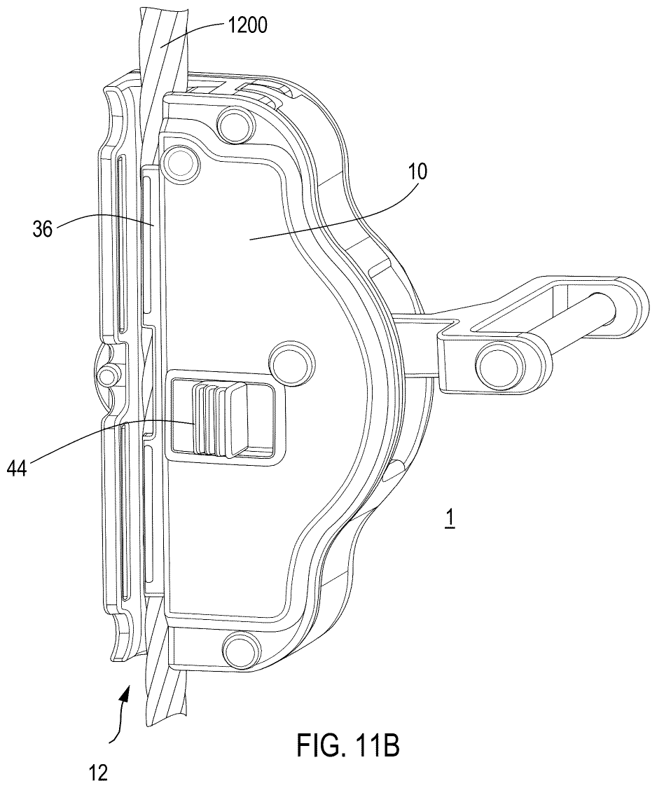

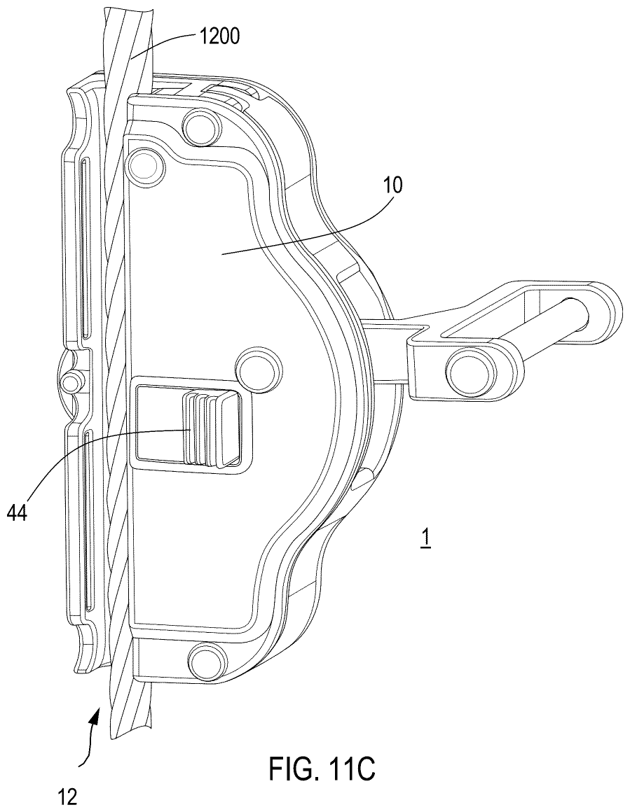

Referring now to FIG. 2, a perspective view of the presently disclosed cable sleeve 1, according to one embodiment, is presented. As shown in FIGS. 2 & 3, the cable sleeve 1 may include a cable engagement side 2 and a harness engagement side 3. The cable sleeve 1 may also include a top 4 and a bottom 5, wherein the safety cable 1200 travels through the cable sleeve 1 on the cable engagement side 2 from top 4 to bottom 5 (as shown in FIGS. 11A-11C). The harness engagement side 3 may be intended for either direct attachment to a safety harness, or attachment to a connector which attaches directly to a safety harness. An exploded view of the cable sleeve 1 is presented in FIG. 3, according to one embodiment.

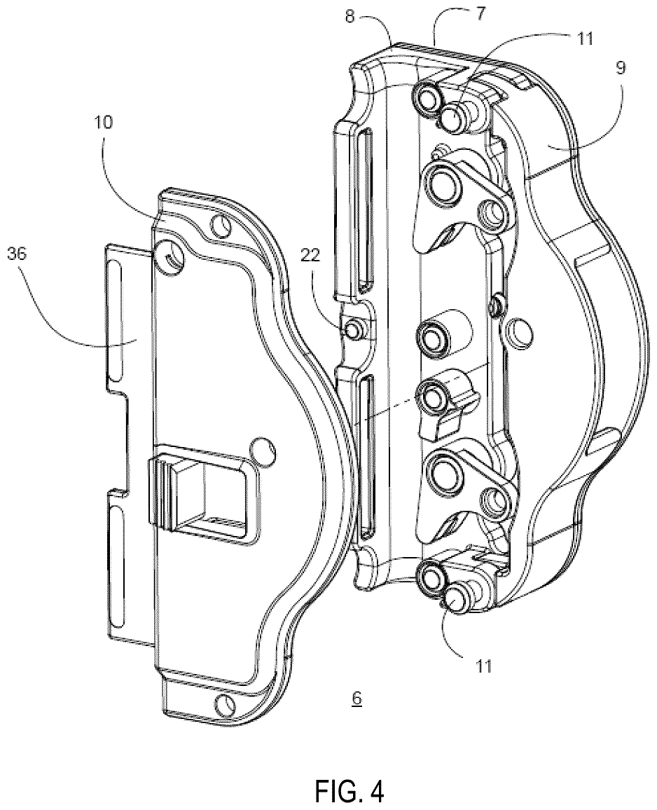

The chassis 6 of the cable sleeve 1, one embodiment of which is shown in FIG. 4, and may be comprised of a lower cover 7, a cable guide 8, a rear spacer 9, and a fixed upper cover 10, all of which may be attached together to form the chassis 6 using one or more through body connection rivets 11 and a front body rivet 22. The chassis 6 is shown in FIG. 4, with the fixed upper cover 10 removed from the lower cover 7 according to one embodiment. The chassis 6, according to some embodiments, may be designed to house the internal locking mechanism as well as the necessary components to facilitate a secure attachment function for the cable sleeve 1 to the safety cable 1200. According to some embodiments, the chassis 6 may be designed to protect the internal components of the cable sleeve 1 from external impacts with other safety equipment, tools, the wearer's body, the ladder 1100, or any other external objects which may cause the internal mechanism of the cable sleeve 1 to malfunction or not function at all. Likewise, according to some embodiments, each of the internal components (discussed further herein) may utilize the chassis 6 as a mounting location to keep the internal components in place relative to each other.

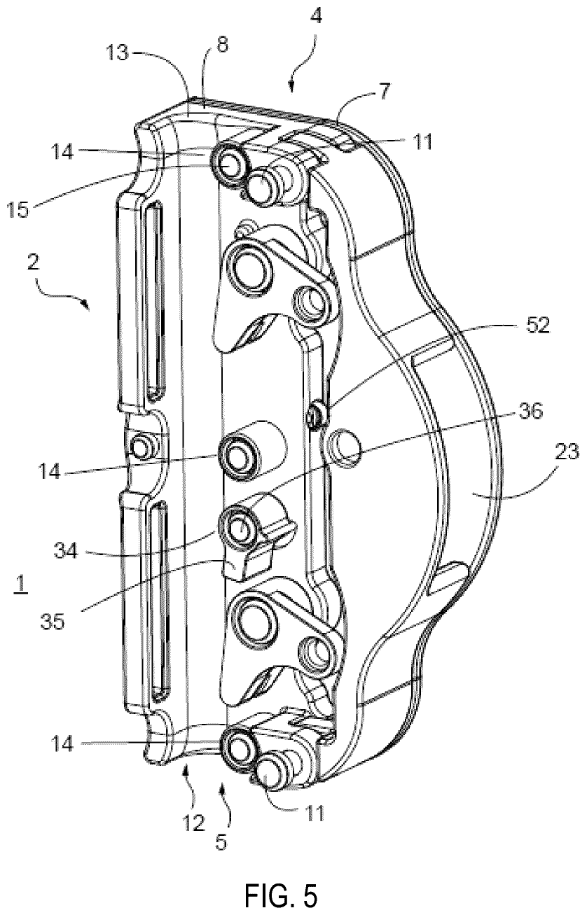

One embodiment of the internal mechanism of the cable sleeve 1 as depicted in FIG. 5 may comprise various internal components arranged in an orientation to facilitate the passage of a safety cable 1200 throughout. More specifically, in certain embodiments, the cable engagement side 2 of the cable sleeve 1 may include a cable guide 8 which may be comprised of a piece of material spanning from the top 4 to the bottom 5 of the cable sleeve 1. In certain embodiments, the cable guide 8 may be attached to the lower cover 7 via through body connection rivets 11. The cable guide 8 may comprise a single piece of material and may include a cable channel 12 which spans from the top 4 to the bottom 5 of the cable sleeve 1. In certain embodiments, the cable channel 12 may include a radiused edge 13 on the cable engagement side 2 with a radius closely matching that of the radius of the particular safety cable 1200 in use.

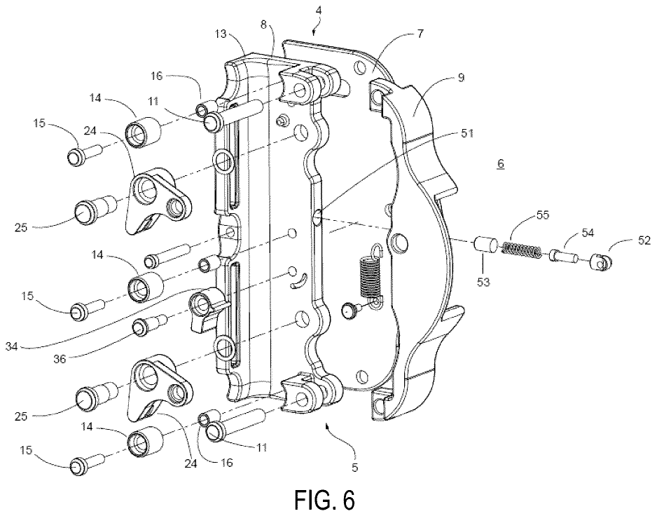

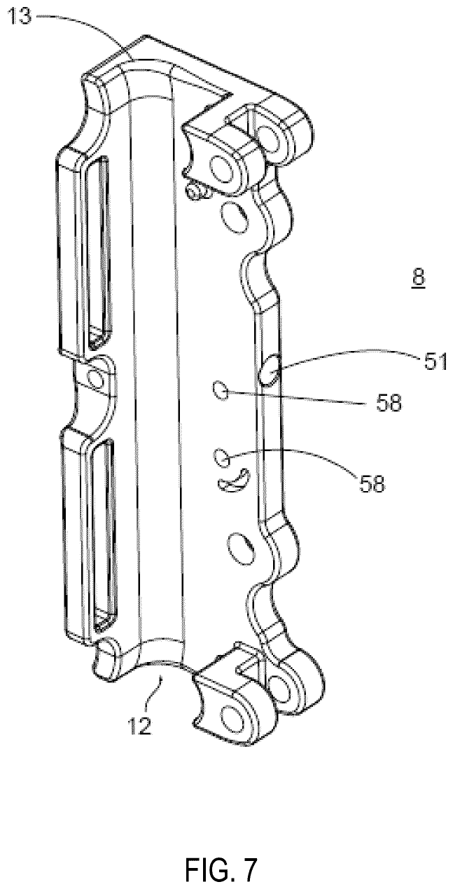

In certain embodiments, the cable 1200 may run through the cable guide 8, using the cable channel 12 as a guide to keep the safety cable 1200 in place. Opposite the radiused edge 13 of the cable channel 12 may be one or more knurled cable guides 14 (depicted in FIG. 6). The knurled cable guides 14 may be spaced a distance apart from the radiused edge 13 of the cable guide 8 sufficient to accommodate a safety cable 1200 within the cable channel 12. The knurled cable guides 14 may be generally cylindrical in shape and may be oriented perpendicular to the vertical axis of the safety cable 1200 such that the knurled cable guides 14 may rotate in place either clockwise relative to the safety cable 1200 when the cable sleeve 1 descends, or counterclockwise when the cable sleeve 1 ascends. In certain embodiments, the safety cable 1200 may be held firmly in place within the cable channel 12, contained on one side by the radiused edge 13 of the cable guide 8, and the knurled cable guides 14 on the other edge. Although the knurled cable guides 14 may keep the safety cable 1200 in place relative to the chassis 6, the knurled cable guides also may facilitate the smooth upward and downward vertical movement of the cable sleeve 1 relative to the safety cable 1200. As such, the knurled cable guides 14 may be secured in place relative to the chassis 6 and the safety cable 1200, but also permitted to rotate in place to permit the safety cable 1200 to travel through the cable sleeve 1. To accomplish this secure yet rotatable attachment to the chassis 6, the knurled cable guides 14 may utilize a guide roller rivet 15 and a guide roller bushing 16. FIG. 7 depicts the cable guide 8 with multiple rivet holes 58 drilled into it. According to some embodiments, the cable guide 8 may include a lateral port 51 extending from the cable engagement side 2 to the harness engagement side 3, as depicted in FIG. 7. In this configuration, the lateral port 51 may contain a threaded portion 52 on the cable engagement side 2 extending a length into the lateral port 51.

Referring back to FIG. 6, in certain embodiments, a guide roller rivet 15 may be inserted through the cable guide 8, and a guide roller bushing 16 is placed over the guide roller rivet 15. The knurled cable guides 14 may then be inserted over the guide roller rivets 15 in order to facilitate secure attachment to the cable guide 8 while simultaneously permitting unrestrained rotation in either direction for the knurled cable guides 14.

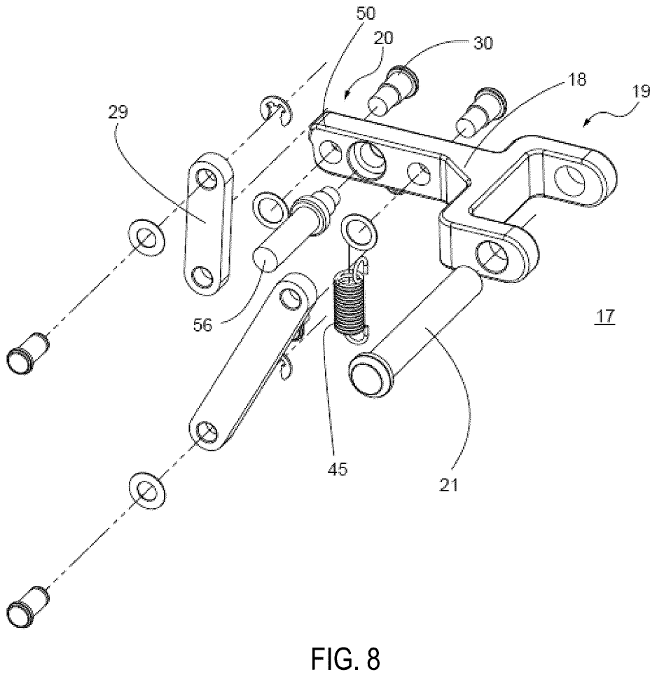

As described above, the presently disclosed cable sleeve 1 is intended to permit unrestrained upwards and downwards vertical movement along a safety cable as part of a personal fall protection system 1000. The cable sleeve 1 may be designed to also lock in place relative to the safety cable 1200 in the case of a worker falling. To understand how the cable sleeve 1 permits both unrestrained vertical movement and rapid locking in case of a fall, it is helpful to first understand how the cable sleeve 1 attaches to the harness of a worker. As depicted in FIG. 3 relative to the rest of the cable sleeve 1, and in more detail in FIG. 8, the harness attachment subassembly 17 may be located on the harness engagement side 3 of the chassis 6. The harness attachment subassembly 17 may be comprised of an activation arm 18 with a shackle end 19 and a pivot end 20.

In certain embodiments, the shackle end 19 may be shaped for direct attachment to a personal energy absorber, for example a shock pack, which may be attached to the shackle end 19 of the activation arm 18 using a personal energy absorber attachment rivet 21, shown in FIG. 8. According to some embodiments, the personal energy absorber attachment rivet 21 may be used to securely attach the first end of the personal energy absorber to the activation arm 18, while the other end of the personal energy absorber may attach to a carabiner for direct attachment to a D-ring or other attachment point on a body harness.

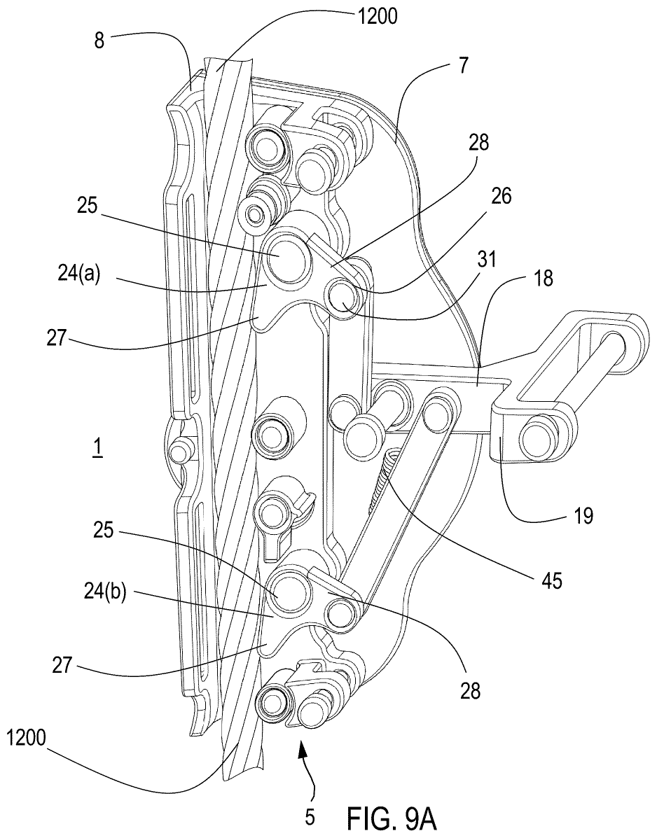

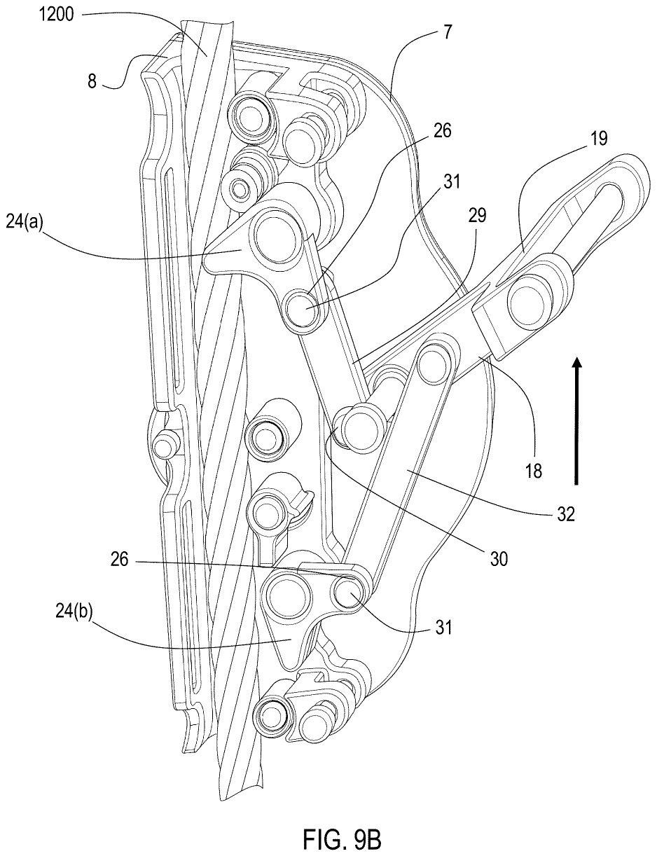

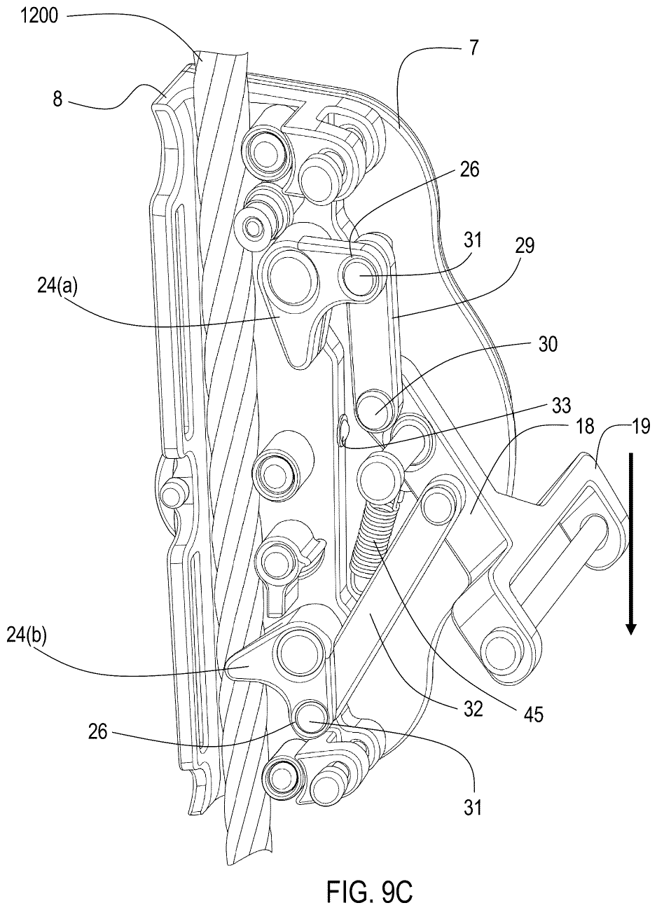

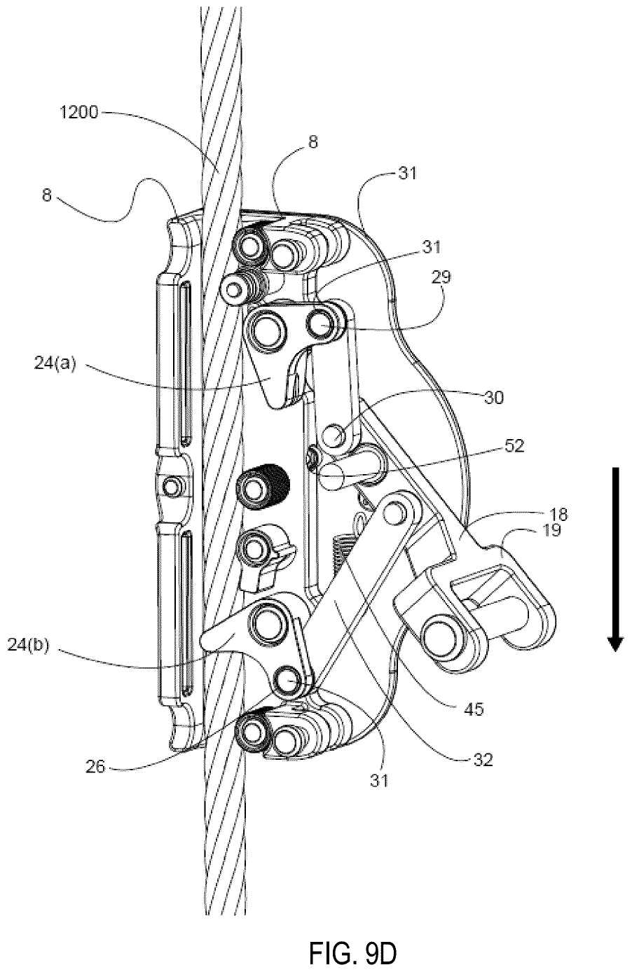

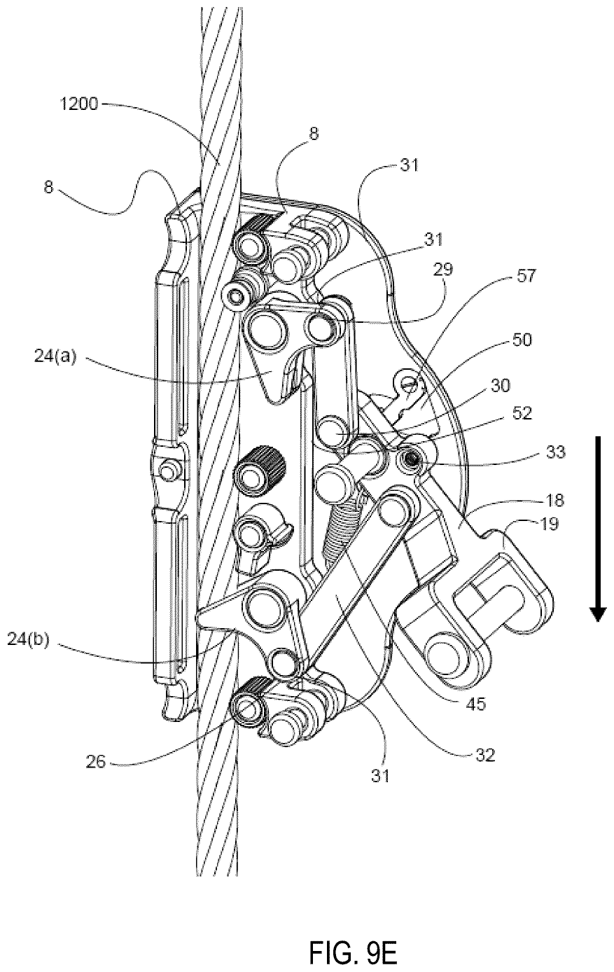

As explained previously, and depicted in FIG. 9A, certain embodiments of the cable sleeve 1 may utilize a chassis 6 comprised of a lower cover 7, a cable guide 8, a rear spacer 9, and a fixed upper cover 10, all of which are attached together to form the chassis 6 using one or more through body connection rivets 11 and a front body rivet 22. In certain embodiments, the pivot end 20 of the activation arm 18 may be inserted partially into the chassis 6 through an elongated rear spacer port 23. Once partially inserted, an activation arm rivet 56 may be inserted first through the pivot end 20 of the activation arm 18, then through the lower cover 7. Once inserted through the pivot end 20 of the activation arm 18 and the lower cover 7, a length of the activation arm rivet 56 can be inserted through the rear spacer 9 and fixed upper cover 10. As a result, the activation arm rivet 56 holds the pivot end 20 of the activation arm 18 in place relative to the rest of the chassis 6, and allows the activation arm 18 to pivot upwards and downwards the distance of the height of the elongated rear spacer port 23, as depicted in FIGS. 9B and 9C. In some embodiments, a remaining length of the activation arm rivet 56 may be inserted through the cover 7, rear spacer 9, and fixed upper cover 10, which along with the one or more through body connection rivets 11 and a front body rivet 22, hold together the cover 7, cable guide 8, rear spacer 9, and fixed upper cover 10 to form the chassis 6 as described previously herein.

In addition to facilitating attachment of the cable sleeve 1 to a harness, the activation arm 18 may also control the locking action of the cable sleeve 1 relative to the safety cable 1200 in some embodiments. Certain safety standards require that cable sleeves include an anti-panic mechanism to ensure the cable sleeve remains fully functional during a fall, even when grabbed by the wearer in a panic. According to certain embodiments, the upward and downward movement of the activation arm 18 may satisfy the anti-panic safety standard by causing the cable sleeve 1 to lock relative to the safety cable 1200 both when the activation arm moves upwards and when it moves downwards. Downward movement of the activation arm 18 is most common, and would typically occur when a person falls off of a ladder 1100 while using a safety system 1000. During a fall, the weight of the worker pulls the activation arm 18 downwards, thereby engaging the locking mechanism of the cable sleeve 1 which locks the cable sleeve 1 in place relative to the safety cable 1200 in order stop the wearer's fall and help prevent fall injuries. Although less common, upward movement of the activation arm 18 may occur when a worker reflexively grabs the cable sleeve 1 during a fall, which without the second independent locking mechanism, may interfere with the cable sleeve's 1 locking mechanism, thereby preventing the cable sleeve 1 from locking onto the safety cable 1200. In some instances, failure of the cable sleeve 1 to engage the safety cable 1200 can result in an uncontrolled fall. Therefore, the presently disclosed cable sleeve 1 may lock onto the safety cable 1200 with both upward and downward movement of the activation arm 18, while still permitting a wearer to ascend and descend under normal circumstances without the cable sleeve locking onto the safety cable 1200.

As described previously (and depicted in FIG. 9A), the safety cable 1200 rides along the cable guide 8, being guided on one side by the radiused edge 13 and the other side being guided by the knurled cable guides 14. While this permits the cable sleeve 1 to travel freely along the safety cable 1200, an additional mechanism is necessary to lock the cable sleeve 1 in place relative to the safety cable 1200 in the case of a fall. To achieve this means, certain embodiments of the cable sleeve 1 may utilize a pair of cable engagement cams 24(a) and 24(b) which are located adjacent to the safety cable 1200 between the cable guide 8 and the fixed upper cover 10. Similar to the knurled cable guides 14, the cable engagement cams 24(a) and 24(b) may attach to the cable guide 8 using cable engagement cam rivets 25. The cable engagement rivets 25 may be inserted first through the cable guide 8, then through the cable engagement cams 24(a) and 24(b), thereby holding the cable engagement cams 24(a) and 24(b) in place relative to the chassis 6 while still permitting the cable engagement cams 24(a) and 24(b) to pivot without resistance. In some embodiments, the cable engagement rivets 25 may be attached through the cable guide 8, but do not extend through the lower cover 7, thereby allowing the lower cover 7 to include a smooth area for placement of labels and to further protect the cable engagement rivets 25 from damage.

As shown in FIG. 9A, each cable engagement cam 24(a) and 24(b) may include a rivet port 26, a cable engagement end 27, and an activation linkage end 28. The cable engagement cams 24(a) and 24(b) may be attached to the cable guide 8 via the cable engagement rivet 25 in an orientation such that the cable engagement end 27 is generally oriented towards the bottom 5 of the cable sleeve 1 when the activation arm 18 is perpendicular to the safety cable 1200.

According to some embodiments, either upward or downward vertical movement of the activation arm 18 may cause simultaneous rotation of the top cable engagement cam 24(a) or bottom cable engagement cam 24(b). Said rotations may be counter-rotational, such that clockwise rotation of one cable engagement cam 24(a) corresponds to counterclockwise rotation of the other cable engagement cam 24(b). Rotation of the cable engagement cams 24 also corresponds with rotations of the cable engagement ends 27 of one of the cable engagement cams 24(a) and 24(b). According to some embodiments, sufficient rotation of the cable engagement cams 24 may result in engagement of the cable engagement end 27 against the safety cable 1200. Sufficient engagement of the cable engagement end 27 against the safety cable 1200 may result in the safety cable being pinched between the cable engagement end 27 and against the cable guide 8. According to some embodiments, the cable engagement end 27 may include a textured or notched point which is designed to increase the friction point between the engagement end 27 and the safety cable 1200 when activated, thereby increasing resistance to slippage of the safety cable 1200.

The movement of the activation arm 18 and the corresponding rotation of the cable engagement cams 24(a) and 24(b) control the locking and unlocking of the cable sleeve 1 and is depicted, according to one embodiment, in FIGS. 9A, 9B, and 9C. According to some embodiments, the activation arm 18 may be independently connected to both cable engagement cams 24(a) and 24(b) via a series of linkages and rivets. To control the rotation of the upper cable engagement cam 24(a), an upper linkage 29 may connect the pivot end 20 of the activation arm 18 to the upper cable engagement cam 24(a). One end of the upper linkage 29 may attach directly to the pivot end 20 of the activation arm using a linkage rivet 30. The use of a linkage rivet 30 permits the upper linkage 29 to be pivotally connected to the activation arm 18. The other end of the upper linkage 29 may attach directly to the rivet port 26 of the upper cable engagement cam 24(a) using a linkage pin 31 which permits the upper cable engagement cam 24(a) to be pivotally connected to the upper linkage 29. As a result, upward movement of the activation arm 18, represented by the arrow in FIG. 9B, causes the engagement of the upper cable engagement cam 24(a) on the safety cable 1200.

The pivot end 20 of the activation arm 18 may also be connected to the lower cable engagement cam 24(b) using a lower linkage 32. One end of the lower linkage 32 may attach directly to the pivot end 20 of the activation arm 18 via a linkage pin 31, which permits the lower linkage 32 to remain pivotally attached to the activation arm 18. The other end of the lower linkage 32 may attach directly to the rivet port 26 of the lower cable engagement cam 24(b) using a linkage pin 31 which permits the lower cable engagement cam 24(b) to be pivotally connected to the lower linkage 32. As a result, downward movement of the activation arm 18, represented by the arrow in FIG. 9C, may correspond with engagement of the lower cable engagement cam 24(b) with the safety cable 1200. And since the activation arm 18 may be independently connected to the upper cable engagement cam 24(a) via the upper linkage 29, and the lower cable engagement cam 24(b) via the lower linkage 32, vertical movement of the shackle end 19 of the activation arm 18 may result in simultaneous rotation of both cable engagement cams 24(a) and 24(b). When the activation arm 18 is substantially perpendicular to the safety cable 1200, as shown in FIG. 9A, neither cable engagement cam 24 engages the safety cable 1200 and the cable sleeve 1 may travel up or down the safety cable 1200.

As explained previously, the cable sleeve 1 is designed with a bi-directional locking mechanism that is actuated by movement of the activation arm 18, such that sufficient upward or downward movement of the activation arm 18 results in the cable sleeve 1 locking relative to the safety cable 1200. However, it is generally only desirable for the cable sleeve 1 to lock relative to the safety cable in the case of a fall, or when the activation arm 18 is pressed upwards rapidly such as when a wearer grabs the cable sleeve 1 reflexively during a panicked fall. Lockups without a fall, referred to as nuisance lockups, may occur if the activation arm 18 is permitted to freely pivot as the climber moves up and down the ladder 1100.

Without a means to limit the movement of the activation arm 18, the activation arm 18 may freely pivot up and down in response to various forces encountered during normal use. Such forces may include the weight of the activation arm 18 and any components attached thereto, the downward force of gravity, upward forces imparted by a climber during ascent or descent of the ladder 1100, and minor frictional forces between the cable sleeve 1 and the safety cable 1200 when in an unlocked configuration. As a result, the activation arm 18 may oscillate or move unintentionally, potentially causing intermittent or unintended engagement of one or both cable engagement cams 24(a), 24(b). Such unintended engagements, commonly referred to as nuisance lockups, may be disruptive to normal climbing movement and, in some cases, may create hazardous conditions for the climber.

In order to prevent the cable engagement cams 24(a) and 24(b) from engaging the safety cable 1200 during normal ascension and descension, the activation arm 18 should remain substantially perpendicular to the safety cable 1200 during normal operations. By keeping the activation arm 18 substantially perpendicular to the safety cable 1200, in the position shown in FIG. 9A, this may prevent both the top and bottom cable engagement cams 24(a) and 24(b) from rotating and engaging the safety cable 1200.

Various methods of controlling unwanted movement of the activation arm 18 are contemplated in the present disclosure. For example, in some embodiments, the pivot end 20 of the activation arm 18 may include a ball indent 50 (depicted in FIG. 8) which, when the activation arm 18 is perpendicular to the safety cable 1200, may be designed to couple with a spring ball detent 33 located on the cable guide 8 (depicted in FIG. 9C). Use of a ball indent 50 with a spring ball detent 33 keeps the activation arm 18 generally perpendicular to the safety cable 1200 under normal conditions. However, if sufficient vertical force is applied to the activation arm 18 such as during a fall, the rapid upward or downward force applied to the activation arm 18 may be sufficient to overcome the coupling between the ball indent 50 and the spring ball detent 33 such that the activation arm 18 may move upwards or downwards to engage the cable engagement cams 24 and lock the cable sleeve 1. In some embodiments, the strength of the engagement between the ball indent 50 and the spring ball detent 33 may be adjusted by changing the depth of the ball indent 50 or the length or spring force of the spring ball detent 33.

According to another embodiment, as depicted in FIG. 9D, unwanted movement of the activation arm 18 is controlled through engagement between a ball indent 50 formed on the activation arm 18 and a ball bearing detent 52 positioned within the cable guide 8. In certain embodiments, the ball bearing detent 52 is configured to protrude outwardly from the cable guide 8 by an adjustable amount, such that the force of engagement between the ball bearing detent 52 and the ball indent 50 may be selectively varied. By adjusting the extent to which the ball bearing detent 52 extends from the cable guide 8, the force required to disengage the activation arm 18 may be increased or decreased, thereby allowing the resistance to unintended movement of the activation arm 18 to be tuned for different operating conditions or safety requirements.

According to some embodiments, adjustment of the ball bearing detent 52 is performed by loosening or tightening a set screw 53 located on the engagement side 3 of the cable guide 8, as depicted in FIG. 6. The set screw 53 may be designed to engage with the threaded portion 52 of the lateral port 51, and may comprise any suitable head type, including, by way of example, an Allen (hex) head, Phillips head, flathead, Torx, or similar alternative, to facilitate manual or tool-assisted adjustment. The set screw 53 may attach to a detent plunger 54 on the opposite end. In certain embodiments, the detent plunger 54 connects to a detent spring 55, which applies an outward force to the ball bearing detent 52 toward the harness engagement side 3.

In some embodiments, the set screw 53, detent plunger 54, detent spring 55, and ball bearing detent 52 are arranged laterally within the cable guide 8. As a result, tightening the set screw 53 within the threaded portion 52 causes the detent plunger 54 and detent spring 55 to shift laterally toward the harness engagement side 3, thereby moving the ball bearing detent 52 outwardly toward the ball indent 50 on the activation arm 18. This arrangement allows precise calibration of the engagement force between the ball bearing detent 52 and the activation arm 18 while maintaining compact lateral packaging within the cable guide 8.

According to another embodiment, shown in FIG. 9E, movement of the activation arm 18 may be controlled through the engagement between a spring ball detent 33 located on the top of the activation arm 18 and a ball indent 50 located on the lower cover 7. In this embodiment, the spring ball detent 33 may pivot with the activation arm 18, and the ball indent 50 may be a cutout portion of the lower cover 7. According to some embodiments, movement of the activation arm 18 is controlled by the spring ball detent 33 engaging and disengaging with the ball indent 50. Movement of the activation arm 18 may be further controlled by an activation arm gate 57, which may be a spring-loaded gate located adjacent to the ball indent 50 on the lower cover 7. The activation arm gate 57 may be biased upwards by an internal spring, and in the closed position forms a lower wall portion of the ball indent 50. When the activation arm gate 57 is in the closed configuration, upward movement of the activation arm 18 may require the spring ball detent 33 to compress a sufficient amount to pass over the top of the activation arm gate 57. Once the spring ball detent 33 clears the top surface of the activation arm gate 57, the spring ball detent 33 may decompress into the ball indent 50, holding the activation arm 18 in place. According to some embodiments, this configuration helps control the movement of the activation arm 18 by requiring a sufficient amount of upward force to compress the spring ball detent 33, thereby ensuring that minor upward movements of the activation arm 18 do not cause nuisance lockups. According to some embodiments, when the activation arm 18 pivots downwards, such as in the case of a fall, the downward force of the activation arm 18 may be sufficient to overcome the force of the spring in the activation arm gate 57, such that the spring ball detent 33 pushes the activation arm gate 57 open and away from the ball indent 50. Once this occurs, spring ball detent 33 is no longer contained within the ball detent 50 by the activation arm gate 57, and as a result, the activation arm 18 may freely pivot downwards. Once the spring ball detent 33 pivots a sufficient distance beyond the activation arm gate 57, the activation arm gate 57 may reset back upwards into the closed configuration described above as a result of the spring within the activation arm gate 57. In this embodiment, the amount of force required to push the activation arm 18 and spring ball detent 33 upwards over the activation arm gate 57 in the closed configuration may be greater than the force required to pull the activation arm 18 and spring ball detent 33 downwards through the activation arm gate 57.

In addition to the various ball-detent methods of controlling unwanted activation arm 18 movement, certain embodiments of the cable sleeve 1 may utilize an activation engagement spring 45 to apply a constant downward bias to the activation arm 18 as depicted in FIGS. 9A, 9C, 9D, and 9E. As described previously, the anti-panic mechanism is designed to activate when sufficient upward movement of the activation arm 18 (as depicted in FIG. 9B) causes the cable sleeve 1 to engage with the safety cable 1200, thereby locking the cable sleeve 1 in place even when the activation arm 18 is inadvertently pushed upwards during a panic. However, the activation arm 18 is also subjected to upward forces during regular use, including by way of example when a climber ascends a ladder along the safety cable 1200. When a climber ascends a ladder, the weight of the cable sleeve 1 along with the friction of the cable sleeve 1 moving along the safety cable may cause the activation arm 18 to have a tendency to pivot upwards relative to the chassis 6 of the cable sleeve 1. If the activation arm 18 is permitted to pivot too far upwards during a climb, a nuisance lockup may occur.

In addition to helping reset the activation arm 18 after the anti-panic mechanism is engaged, the activation engagement spring 45 may also help reduce accidental engagements of the cable engagement cams 24(a) and 24(b), particularly when ascending a ladder 1100, by further reducing unwanted movement of the activation arm 18. More specifically, in certain embodiments, the activation engagement spring 45 may be a tension spring designed to apply a constant downwards force onto the activation arm 18, intended to counteract the upward forces applied onto the activation arm 18 during the regular course of use. In some embodiments of the cable sleeve 1, one end of the activation engagement spring 45 may attach directly to the side of the activation arm 18, while the other end may attach directly to the inside of the lower cover 7. In certain embodiments, the activation engagement spring 45 may apply a variable downward force onto the activation arm 18 such that when the activation arm 18 is perpendicular to the safety cable 1200, only a small force is applied, and as the activation arm 18 moves upwards (such as when the wearer takes a large step), the downward force increases to prevent a nuisance lockup.

However, while the forces described above may be sufficient to counteract nominal forces resulting from regular operation during ascension and descension, these forces may be intentionally calibrated so that they can be overcome when a climber experiences a fall event or panic response. In such circumstances, the increased upward or downward forces applied to the activation arm 18 exceed the biasing force of the activation engagement spring 45, the ball indent 50, the spring ball detent 33 and/or the ball bearing detent 52, thereby allowing the activation arm 18 to pivot upwardly or downwardly to engage the cable engagement cams 24(a) and 24(b) with the safety cable 1200 and initiate a locking condition.

Certain safety standards may further require mechanisms to ensure the cable sleeve 1 can only be installed in one direction relative to the safety cable 1200. To satisfy these requirements, certain embodiments of the cable sleeve 1 may include an anti-inversion cam 34 to ensure the cable sleeve 1 is installed in the correct orientation relative to a safety cable 1200. Shown in FIGS. 5 & 6, the anti-inversion cam 34 may be shaped similarly to the cable engagement cam 24 except that it includes a channel block 35 instead of a rivet port 26. According to some embodiments, the anti-inversion cam 34 may attach directly to the cable guide 8 using an anti-inversion rivet 36, which is designed to permit the anti-inversion cam 34 to freely rotate approximately ninety degrees relative to the cable guide 8. When the cable sleeve 1 is in the correct orientation such that the top 4 of the cable sleeve 1 faces upwards and the bottom 5 faces downwards, the anti-inversion cam 34 is designed to automatically rotate from gravity such that the channel block 35 of the anti-inversion cam 34 faces downwards and the channel block 35 does not block the cable channel 12. In comparison, if the cable sleeve 1 is flipped one-hundred-and-eighty degrees so that the top 4 faces towards the ground and the bottom 5 faces upwards, gravity may cause the anti-inversion cam 34 to rotate approximately ninety degrees which causes the channel block 35 to rest directly in the cable channel 12. With the cable channel 12 blocked by the channel block 35, it is not possible to fully install the cable sleeve 1 onto the safety cable 1200 until the cable sleeve 1 is rotated one-hundred-and-eighty degrees into the correct orientation. In certain embodiments, the anti-inversion cam 34 may not engage the safety cable 1200 at any time once the cable sleeve 1 is installed onto the safety cable 1200, and the only purpose of the anti-inversion cam 34 is to prevent the inverted installation of the cable sleeve 1 onto the safety cable 1200.

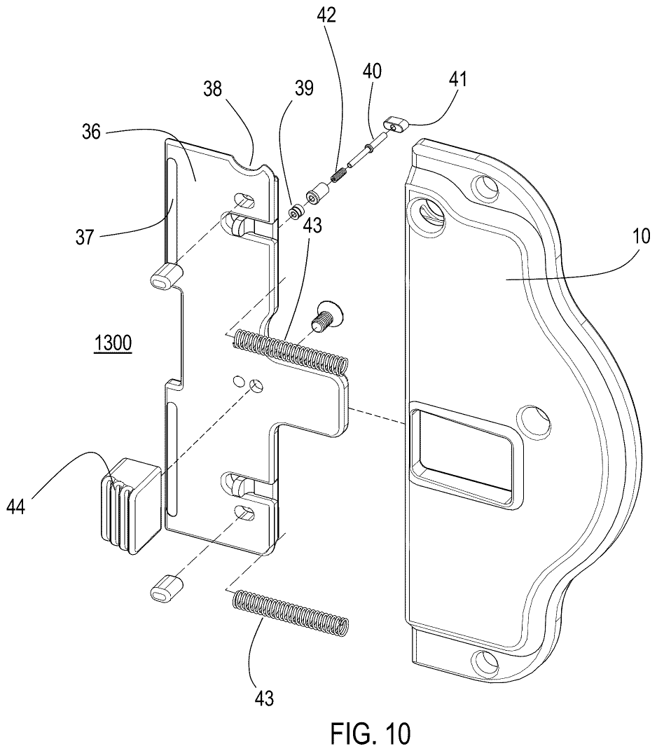

As explained previously, normal operation of the cable sleeve 1 may require that the cable sleeve 1 be installed in a manner such that the safety cable 1200 rests within the cable channel 12. The cable guide 8, cable engagement cams 24(a) and 24(b), and knurled cable guides 14 are designed to guide and lock the safety cable 1200 during use, but are not designed to hold the safety cable 1200 within the cable sleeve 1. In order to prevent the inadvertent release of the safety cable 1200 from the cable channel 12 during normal operation, some embodiments of the cable sleeve 1 may include a dual action locking cover mechanism 1300 (depicted in FIG. 10) which may utilize a spring-guided sliding cover 36 designed to extend over the safety cable 1200 during use, but also easily retract away for rapid attachment and detachment from the safety cable 1200.

As described previously and depicted in FIG. 4, the cable sleeve 1 is comprised of a chassis 6 which includes a fixed upper cover 10. In some embodiments, a sliding cover 36 may be sized to fit into the fixed upper cover 10. The sliding cover 36, shown in FIG. 10 relative to the dual action locking cover mechanism 1300, may utilize one or more slider compression springs 43 which apply a constant outward force onto the sliding cover 36. When in use, the sliding cover 36 may rest in the fully extended position (depicted in in FIG. 11A). In this position, the sliding cover 36 extends fully out of the fixed upper cover 10 and completely covers the safety cable 1200 located in the cable channel 12. As the sliding cover 36 is retracted into the fixed upper cover 10, (shown in FIG. 11B), and eventually fully retracted into the fixed upper cover 10 (shown in FIG. 11C), the safety cable 1200 and/or cable channel 12 (depending on whether cable sleeve is being attached or detached) is eventually fully exposed and the cable sleeve 1 may be either attached or detached to the safety cable 1200.

In some embodiments, the fixed upper cover 10 may be designed to permit only lateral movement (in a direction perpendicular to the channel guide 12) of the sliding cover 36. When in the fully extended position (shown in FIG. 11A), the flanges 37 located on the sliding cover 36 (shown in FIG. 10) extend through the cable guide 8, thereby preventing the sliding cover 36 from being pushed away from the cable channel 12 from the force of a fall. In some embodiments, the flanges 37 may be painted a different color than the cable guide 8 and sliding cover 36 so that a worker may quickly discern whether the flanges 37 are fully secured though the cable guide 8.

As explained above, the sliding cover 36 is intended primarily to prevent the cable sleeve 1 from accidentally detaching from the safety cable 1200 during use. To prevent this accidental detachment, the sliding cover 36 may be locked into the fully extended position (FIG. 11A) via a safety catch 39 which prevents the sliding cover 36 from being inadvertently retracted during use. In some embodiments, the sliding cover 36 may include a radiused safety release notch 38 sized to accept the safety catch 39 (shown in FIG. 10). The safety catch 39 is located at one end of a plunger shaft 40, while the other end includes a finger pad 41. The plunger shaft 40 is attached to the chassis by being inserted through the lower cover 7 and upper cover 10, and runs perpendicular to the direction in which the sliding cover 36 moves. In between the safety catch 39 and the finger pad 41 lies a plunger spring 42, which applies a constant outward force on the finger pad 41. This constant outward force on the finger pad 41 necessarily results in the safety catch 39 being continuously biased inwards towards the sliding cover 36. In some embodiments, the safety catch 39 fits directly into the release notch 38 located on the sliding cover 36 when the sliding cover 36 is fully extended, as shown in FIG. 11A. When the safety catch 39 fits into the release notch 38, the sliding cover 36 is blocked from lateral movement, thereby locking the sliding cover 36 into the fully extended position shown in FIG. 11A. To release and retract the sliding cover 36 for attachment or detachment of the cable sleeve 1 to a safety cable 1200, an operator must press and hold the finger pad 41 which causes the safety catch 39 to move out of the way of the release notch 38. With the safety catch 39 no longer blocking the release notch 38, the sliding cover 36 may be freely retracted (shown in FIGS. 11B and 11C). In some embodiments, the safety catch 39 may also be painted a different color than the upper cover 10 so a worker can quickly discern whether or not the safety catch 39 is engaged with the release notch 38.

In addition to the release notch 38 and safety catch 39 ensuring that the sliding cover 36 does not inadvertently retract, certain embodiments of the cable sleeve 1 may also employ one or more slider compression springs 43, shown in FIG. 10, which exert a constant outwards force onto the sliding cover 36. Said slider compression springs 43 help keep the sliding cover 36 fully extended, as shown in FIG. 11A. Even when the safety catch 39 is released, the compression springs 43 may help keep the sliding cover 36 extended over the safety cable 1200. While the compression springs 43 maintain a constant force on the sliding cover 36, the force may be overcome by manually pulling the sliding cover 36 towards the retracted position (FIG. 11C). To assist with overcoming the force of the compression springs 43, certain embodiments of the present invention may include a slider tab 44 located on the external surface of the sliding cover 36. The slider tab 44 allows an operator to gain a better grip of the sliding cover 36 to overcome the force of the compression springs 43.

As a result of the compression springs 43 and the safety catch 39, removal or attachment of the cable sleeve 1 is a two-step process. First, the worker must unlock the sliding cover 36 by pressing and holding the finger pad 41. This causes the safety catch 39 to unblock the release notch 38, thereby allowing the sliding cover 36 to be retracted. As the plunger spring 42 is applying a constant outward force on the finger pad 41, the worker must hold the finger pad 41 for as long as they wish the keep the sliding cover 36 unlocked. Once unlocked, a worker then must pull the slider tab 44 towards the harness engagement side 3 of the chassis 6 with sufficient force to overcome the compression springs 43. Once a sufficient force is applied to the sliding cover 36 to overcome the compression springs 43, the sliding cover 36 may be retracted thereby exposing the cable channel 12 for installment or removal of the safety cable 1200. To reset the sliding cover 36 over the safety channel 12 and/or the safety cable 1200 the operator simply releases the slider tab 44 and allows the force of the compression springs 43 to return the sliding cover 36 back to the fully extended position shown in FIG. 11B. While releasing the slider tab 44, the operator may also simultaneously release the finger pad 41, and once the sliding cover returns to the fully extended position, the force resulting from the plunger spring 42 may automatically cause the safety catch 39 to reengage with the safety release notch 38. The automatic reengagement of the safety catch 39 into the safety release notch 38, finalizes the re-locking of the dual action locking cover mechanism 1300. According to some embodiments, removal or attachment of the cable sleeve 1 may be performed using one hand by the worker to which the cable sleeve 1 is attached.

While various embodiments of the present disclosure have been described in detail, it should be apparent that modifications and variations thereto are possible, all of which fall within the true spirit and scope of the disclosure. For example, various other embodiments may not require all subassemblies to be present, or may include other similar subassemblies. One such example is that the cable sleeve may include some but not all safety features.

Additionally, various embodiments may utilize multiple of the same subassemblies. For example, certain embodiments may utilize two or more anti-inversion cams, or may include multiple sliding cover locks. Other embodiments may include different locks for the sliding cover.

Similarly, other embodiments may also include variations to how the cable engagement cams engage and disengage the safety cable, as well as variations for how the activation arm controls the cable engagement cams.

Therefore, the foregoing is intended only to be illustrative of the principles of the disclosure. Further, since numerous modifications and changes will readily occur to those skilled in the art, it is not intended to limit the disclosure to the exact construction and operation shown and described. Accordingly, all suitable modifications and equivalents may be included and considered to fall within the scope of the disclosure, defined by the following claim or claims.

The terminology used herein is for the purpose of describing particular embodiments only and is not intended to be limiting of the disclosure. As used herein, the term “and/or” includes any and all combinations of one or more of the associated listed items. As used herein, the singular forms “a”, “an” and “the” are intended to include the plural forms as well as the singular forms, unless the context clearly indicates otherwise. It will be further understood that the terms “comprises” and/or “comprising” when used in this specification, specify the presence of stated features, steps, orientations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the relevant art. It will be further understood that terms, such as those defined in commonly used dictionaries, should be interpreted as having a meaning that is consistent with their meaning in the context of the relevant art and the present disclosure and will not be interpreted in an idealized or overly formal sense, unless expressly so defined herein.

It will be understood that a number of techniques and steps relating to the disclosure are presented. Each of these has individual benefits and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the inventions and the claims.

What is claimed is:

1. A cable sleeve for connecting a safety harness to a safety cable for use in a personal fall arrest system, the cable sleeve comprising:
a chassis;
an anti-panic cam mechanism attached to an activation arm mechanism for attachment to a safety harness; and
a dual-action safety mechanism to release the cable sleeve from the safety cable,
wherein the activation arm is configured for attachment to one or more cable engagement cams so that upward and downward movement of the anti-panic cam causes the one or more cable engagement cams to engage the safety cable thereby locking the cable sleeve in place relative to the safety cable in the case of a downward fall or upward panic motion.

2. The cable sleeve of claim 1 wherein the chassis is comprised of a lower cover, a cable guide, and a fixed upper cover.

3. The cable sleeve of claim 1 wherein when the activation arm mechanism is biased in an upward direction, the anti-panic cam mechanism engages the safety cable locking the cable sleeve in place relative to the safety cable; when the activation arm mechanism is biased in a downward position, the cable engagement cam mechanism engages the safety cable locking the cable sleeve in place relative to the safety cable; and when the activation arm mechanism is unbiased, the cable sleeve may move vertically relative to the safety cable.

4. The cable sleeve of claim 1 wherein the dual-action safety mechanism is comprised of a spring actuated gate mechanism and a push button release, wherein removal of the cable sleeve requires an operator to simultaneously disengage the push button release and pull the spring actuated gate mechanism back to release the cable sleeve from the safety cable.

5. The cable sleeve of claim 1 wherein the activation arm mechanism comprises an activation arm with a shackle end and a personal energy absorber attachment rivet; the shackle end and personal energy absorber attachment rivet engaging a personal energy absorber which engages on a first end with the personal energy absorber attachment rivet and the second end with a harness receptor worn on the chest of a worker; wherein when the activation arm is in an unbiased position, the activation arm remains generally perpendicular to the axis of the safety cable.

6. The cable sleeve of claim 1 wherein the activation arm mechanism comprises an activation engagement spring which applies a constant downward force onto the activation arm to prevent the cable sleeve from engaging the safety cable during a controlled ascent.

7. The cable sleeve of claim 1 wherein the activation arm mechanism comprises a ball indent which engages with a ball detent located on the cable guide which prevents the activation arm from pivoting during a controlled ascent or descent.

8. The cable sleeve of claim 1 wherein the cable sleeve further comprises an anti-inversion cam.

9. The cable sleeve of claim 7 wherein the ball detent is adjustable via a set screw, such that the protrusion of the ball detent from the cable guide and the corresponding engagement force with the ball indent can be selectively varied.

10. The cable sleeve of claim 7 wherein the anti-inversion cam is a cam that freely rotates within the chassis such that when the chassis is in the correct vertical orientation, the anti-inversion cam rotates downward providing an open safety cable channel, and when the chassis is incorrectly inverted, the anti-inversion cam rotates into the safety cable channel preventing the safety cable from fitting into the cable sleeve.
